(19) United States
(12) Patent Application Publication
(10) Pub. No.: US 2009/0156305 A1
(43) Pub. Date: Jun. 18, 2009

(54) Insertion of Graphics into Video Game

(75) Inventor: Paul J. Thelen, Seattle, WA (US)

Correspondence Address: LEE & HAYES, PLLC, 601 W. RIVERSIDE AVENUE, SUITE 1400, SPOKANE, WA, 99201, US

(73) Assignee: Big Fish Games, Inc., Seattle, WA (US)

(21) Appl. No.: 12/392,034

(22) Filed: Feb. 24, 2009

Related U.S. Application Data
(63) Continuation of application No. 11/756,577, filed on May 31, 2007.
(60) Provisional application No. 60/895,059, filed on Mar. 15, 2007.

(51) Int. Cl. A63F 13/00

(52) U.S. Cl. 463/31

(57) ABSTRACT

A video computer game is described that enables a user to generate and play a customized video game. The user retrieves a user generated pictorial background for placement in a graphics window in the game. User generated or previously provided objects are selected for placement on the background object. The pictorial background and selected objects are combined in a graphics window for editing. A list corresponding to the selected objects is automatically created and placed in a list window of the game. The game may then be published or may be played privately by the user. During play of the game, the objects in the graphics window are selected and a selection indication is provided.

### CROSS REFERENCE TO RELATED MATTERS

This application is a continuation of U.S. non-provisional patent application Ser. No. 11/756,577 entitled “INSERTION OF GRAPHICS INTO VIDEO GAME” filed May 31, 2007 to Paul J. Thelen which is currently pending which claims benefit of U.S. provisional patent application Ser. No. 60/895,059 filed on Mar. 15, 2007, all of which are herein incorporated by reference.

### BACKGROUND

Currently, various hidden object electronic video games are available on the market. These hidden object games display objects hidden in a pictorial background in a game window. A list containing hidden objects is simultaneously displayed in a textual or list window. The objective of the game is for the game player to select the hidden objects in the game window until all the objects on the list are found.

The background and objects to be hidden are provided by a game developer. This game developer typically has substantial skills in graphics design, programming and game development. Further the position and orientation of the objects are likewise provided. These games do not allow creative control of the background or objects by the game player. Further once the game is played, the player may have to wait a substantial amount of time for the game development to occur before obtaining a new game with different backgrounds and hidden objects.

Illustrated in FIG. 1 is an exemplary display 100 of one scene of an exemplary hidden object video game. The display includes a game window 102 and a list window 104. The game window 102 includes various objects, such as exemplary circle 106a, oval 106b and rectangle 106c. The list window 104 may include text 108 corresponding to the objects 106(a-c) in the game window.

Illustrated in FIG. 2 is an exemplary process 200 for playing the hidden objects video game. The game is launched by the user (also referred to as a game player) in block 202, and a background graphic along with various objects 106(a-c) are displayed in game window 102. In block 206, a list of objects 106(a-c) to be found in the game window 102 is displayed in list window 104. In block 208, a game player using an input device finds and then selects one or more of the various objects 106(a-c) from the game window 102 corresponding to objects in the list 108. In block 210 the selected objects are removed from the list 108. An indication of the selection (such as by animating the object) is performed in response to selecting an object for the first time in the game window 102.

In block 212, a determination is made whether all the objects have been removed from list 108. If not, the user selects more objects from the list in block 208. If all objects have been removed, in block 214, a determination is made whether there is a new list/graphics window in which the game player can select new objects. If there are new list/graphics windows, a new game window 102 and list window 104 are displayed and blocks 204-212 are repeated. If there are no additional list and game windows, the game ends in block 216.

### SUMMARY

A computer implemented game creation system is described that enables a user to affect the video game. The user retrieves a user generated or previously provided pictorial background into a work space for ultimate placement in a graphics window in the video game. User generated or previously provided objects are selected for placement on the background object in the work space. The pictorial background and selected objects are combined from the work space and placed into the graphics window of the game. A textual or visual objects list of the selected objects is automatically created and placed in a list window of the game. The resulting hidden object game is played by the creator or shared via Internet Web sites or via physical media and played by others. During play of the game, the objects in the graphics window are selected and an indication of the selection is provided by using both the list window and the objects in the graphics window.

This summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 depicts an illustrative screen of the hidden object video game.

FIG. 2 depicts an illustrative process for playing a hidden object video game.

FIG. 3 depicts a diagram illustrating insertion of a user generated graphic or photograph along with objects into a screen of the hidden object video game.

FIG. 4 depicts an example system in which the hidden object video game and tool for insertion of graphics into the game may be implemented.

FIG. 5 illustrates an illustrative process for insertion of graphics into the hidden object video game.

### DETAILED DESCRIPTION

The following document describes method(s) or software capable of instantiating a computer video game. The video game may be executed on any electronic device such as a computer, PDA, computer laptop or gaming device. The computer game software is operable to enable a game user to find hidden objects in the video game.

The construction of the video game and an environment in which this video game may be enabled by techniques is set forth first below. This is followed by others sections describing various inventive techniques and illustrative embodiments of other aspects of the video game.

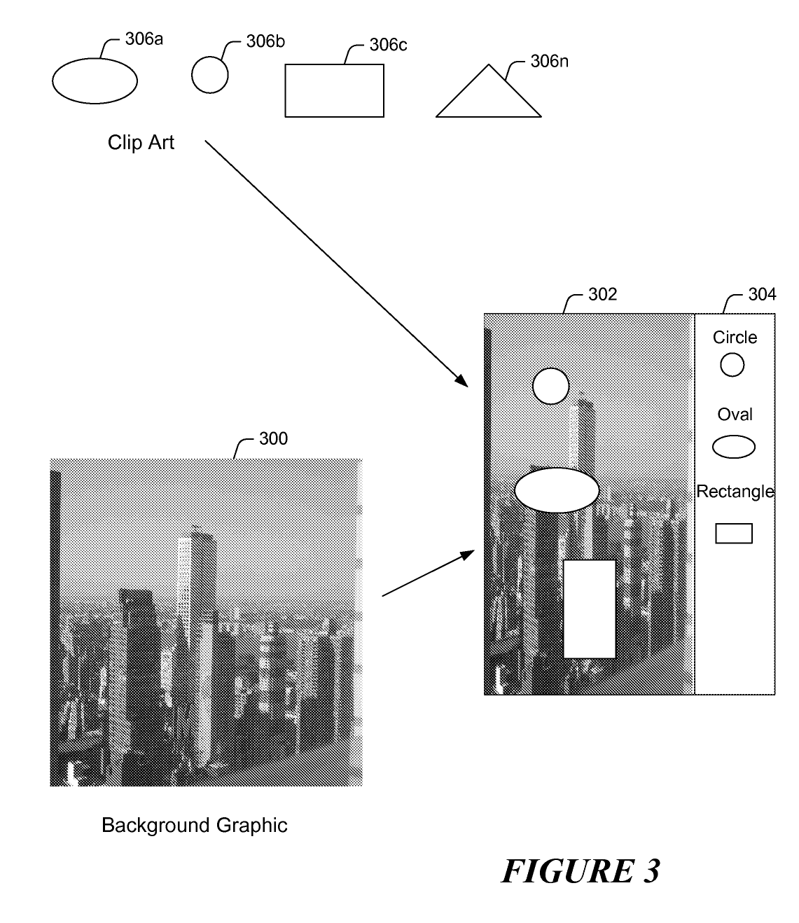

Referring to FIG. 3, depicted is a background graphic 300 and objects 306(a-n) for insertion into game window 302. Background graphic 300 is illustrated as a photograph and objects 306(a-n) are depicted as geometric shapes; however, another type of graphic image or objects could be used and inserted into game window 302. Such graphic images or objects may include animation, video images, photographic elements, cartoon graphics or manually generated graphical or artistic renderings. Background graphic 300 and objects 306(a-n) may be manually created by a game creator or may be provided from a third party artist, web site, service provider or photographer.

When objects 306(a-n) are placed in game window 302, text and/or objects corresponding to the objects 306(a-n) may be automatically depicted as a list window 304. In the illustrated example, a circle, oval and rectangle may be listed in the list window 304 to correspond to the circle object 306b, oval object 306a and rectangle object 306c shown in game window 302. The list window may include only the objects themselves without text, the text corresponding to objects 306a-c or both the text and the objects.

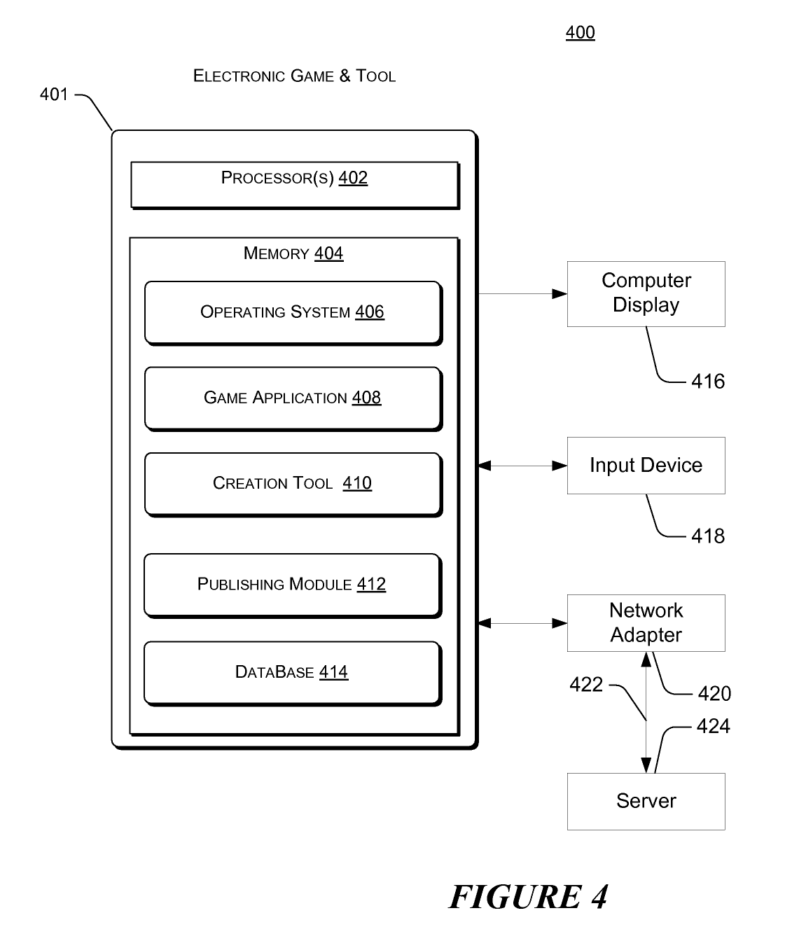

The computer environment 400 illustrated in FIG. 4 is a general computer environment that includes a user interface which can provide a computer video game to a game player or a work space to a game creator; the computer video game may include a game creating and playing portion. Similar resources may use the computer environment and the processes as described herein. The computer environment 400 is only one example of a computer environment and is not intended to suggest any limitation as to the scope of use or functionality of the computer and network architectures. Neither should the computer environment 400 be interpreted as having any dependency or requirement relating to any one or combination of components illustrated in the exemplary computer environment 400.

The computer environment 400 includes a general-purpose computing device in the form of a computer 401. The computer 401 can be, for example, one or more of a stand alone computer, laptop computer, server, a networked computer, a mainframe computer, a PDA, a telephone, a microcomputer or microprocessor, or any other computer device that uses a processor in combination with a memory. The components of the computer 401 can include, but are not limited to, one or more processors or processing units 402, a system memory 404, and a system bus (not shown) that couples various system components including the processor 402 and the system memory 404.

The computer 401 can comprise a variety of computer readable media. Such media may be any available media that is accessible by the computer 401 and includes both volatile and non-volatile media, and removable and non-removable media. The process for creating and playing the video game can be stored as instructions sets on the computer readable media.

The system memory 404 may include the computer readable media in the form of non-volatile memory such as read only memory (ROM) and/or volatile memory such as random access memory (RAM).

The computer 401 may also include other removable/non-removable, volatile/non-volatile computer storage media. By way of example, memory 404 may include a hard disk drive (not shown) for reading from and writing to a non-removable, non-volatile magnetic media (not shown), and an optical disk drive, for reading from and/or writing to a removable, non-volatile optical disk such as a CD-ROM, DVD-ROM, or other optical media. The hard disk drive and optical disk drive may each be directly or indirectly connected to the system bus.

The disk drives and their associated computer-readable media provide non-volatile storage of computer readable instructions, program modules, and other data for the computer 402. Although the example depicts a hard disk within the hard disk drive, it is to be appreciated that other types of the computer readable media which can maintain for accessing data that is accessible by a computer, such as non-volatile optical disk drives, floppy drives, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computer environment 400.

Memory 404 may be a magnetic disk non-volatile optical disk, ROM and/or RAM. Stored in memory 404, including by way of example, may be an operating system (OS) 406, one or more video game applications 408, creation tool 410, publishing module 412, database 414 and other program modules and program data. Although creation tool 410, game application 408, publishing module 412 and database 414 reside together as part of a single application in a memory 404 of computer 401, any combination of such modules, tools, and data may reside on a memory of server 424, while other modules reside in computer 401.

A player can enter commands and information into the computer 702 via input devices 418 such as a keyboard and/or a pointing device (e.g., a “mouse”) which send a signal to the computer 401 in response to commands from the game player. Other input devices (not shown specifically) may include a microphone, joystick, game pad, satellite dish, serial port, scanner, and/or the like. These and other input devices are connected to the processing unit 402 via input/output interfaces (not shown) that are coupled to the system bus of computer 401, but may be connected by other interface and bus structures, such as a parallel port, game port, or a universal serial bus (USB).

A monitor, flat panel display, or other type of computer display 416 can also be connected to the system bus via a video interface (not shown), such as a video adapter. In addition to the computer display 416, other output peripheral devices can include components such as speakers (not shown) which can be connected to the computer 401.

The computer 401 can operate in a networked environment using logical connections to one or more remote computers, such as a remote computer device 424 through network adapter 420 via network 422. By way of example, the remote computer device 424 can be a personal computer, portable computer, a server, a router, a network computer, a peer device or other common network node, game console, and the like. The remote computer device 424 can be a server that can include many or all of the elements and features described herein relative to the computer 401.

Logical connections between the computer 401 and the remote computer device (e.g. a service provider) are depicted as an Internet (or Intranet) which may include a local area network (LAN) and/or a general wide area network (WAN). Video game application 408 may be initially stored on the server 424 and be downloaded from the internet onto memory 404 in computer 401. Computer 401 may communicate to the remote computer device using any Communications Media.

Various modules and techniques may be described herein in the general context of the computer-executable instructions, such as program modules, executed by one or more computers or other devices. Generally, program modules include routines, programs, control objects, components, control node data structures, etc. that perform particular tasks or implement particular abstract data types. Often, the functionality of the program modules may be combined or distributed as desired in various embodiments.

Operating system 406 manages the interaction between the various applications, modules and tools in memory 404 with memory 404 and devices 416-420. Operating system may include a middleware interfaces such as Flash by Adobe Inc. of San Jose, Calif. or Java by Sun Inc. of Santa Clara, Calif. Game application 408 may communicate with the operating system directly or via the middleware interface.

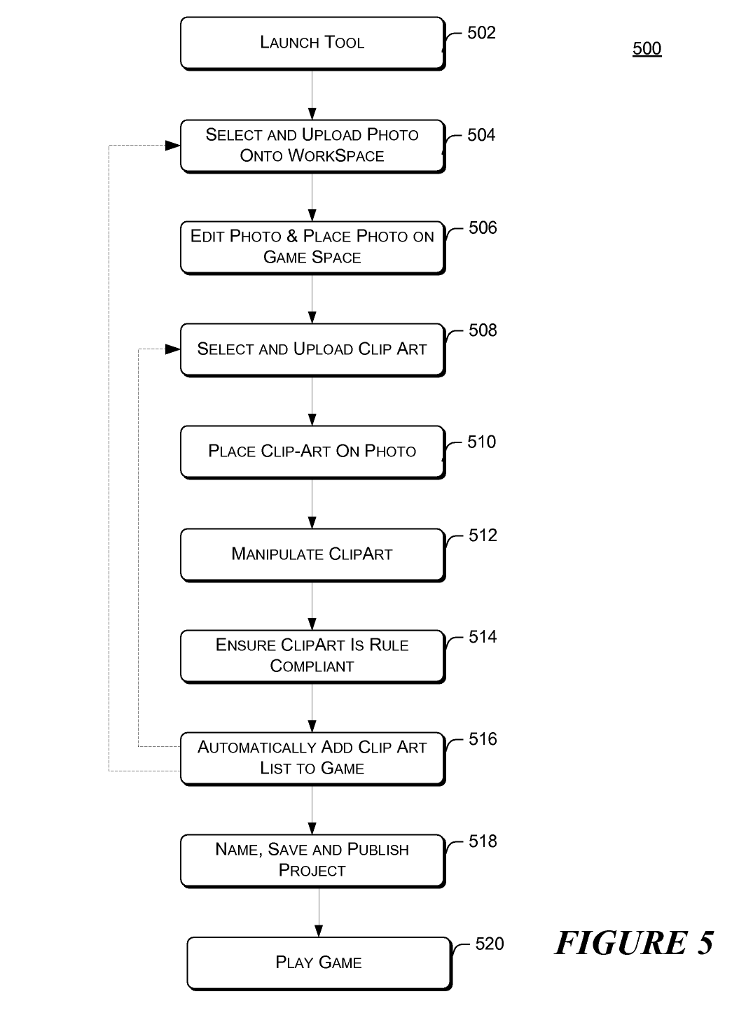

Creation tool 410 is the application that enables the creator to create a hidden object game with selected graphics inserted into the game. Details of the creation tool 410 process are described in FIG. 5.

Publishing module 412 enables the game creator to upload their created hidden object game, i.e. a project, once the project has been created. Publishing module allows uploading of the created game via a network using network adapter 420. The uploaded game may be stored on a server 424 or with a service provider. The amount uploads may be limited by the publishing module or by the service provider. Publishing module 412 may also reside on server 424 and enable distribution of created game application 408.

The graphics and objects to be inserted into the game may be stored in database 414. The game created by the creator may also be stored in database 414 as a project file prior to being published using publishing module 412. Such project file may be automatically saved during game creation and will enable the creator to return to re-edit their project. However, the publishing module 412 may limit changes made by the creator, without renaming the project, once the project has been published.

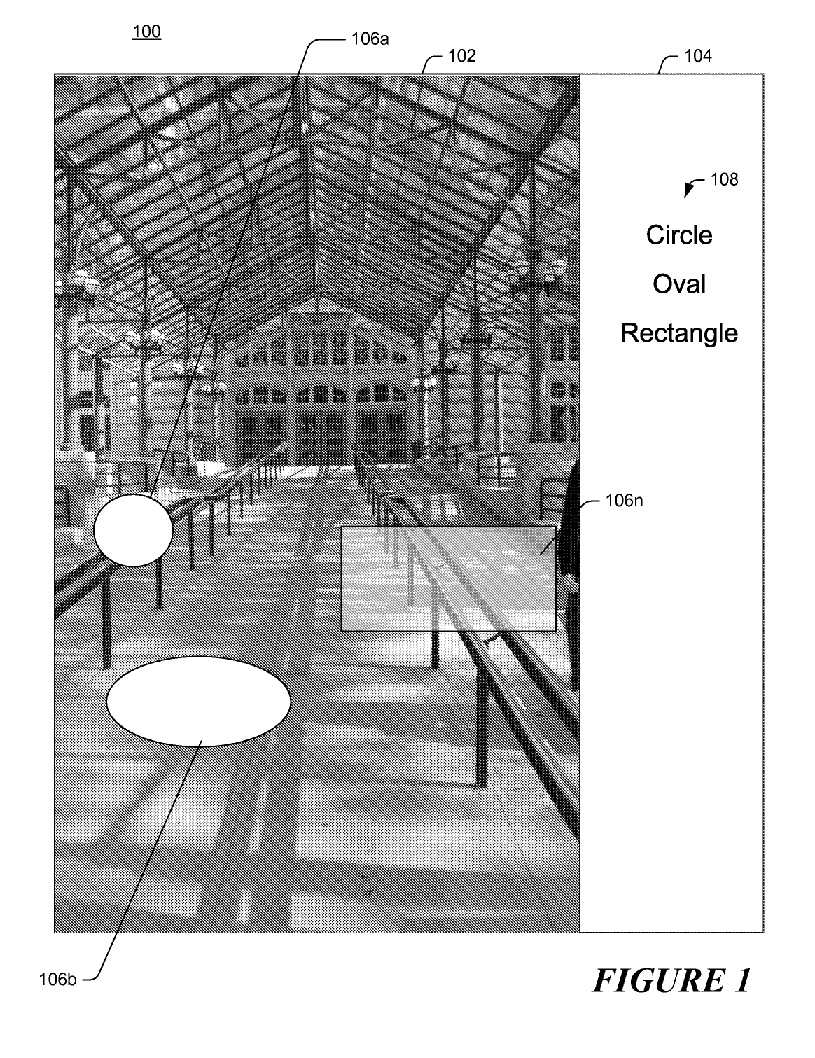

Depicted in FIG. 5 is a flowchart 500 showing the process to create and play the computer video game using the techniques described in FIGS. 1-4. In block 502, a tool is launched that enables the creator to add graphical objects to the hidden object game. Although the graphical objects may be any type of graphical rendering, for the purpose of an example a photograph will be described herein as the exemplary graphical object.

In block 504, the game creator browses their computer for personal photographs and uploads their photographs into a work space provided by the tool. In one embodiment, the creator may choose a photograph from a selection of stock photographs provided from a service provider and uploaded as a stock photograph to a workspace provided by the tool. The photographs may be uploaded and may be created in a JPEG, a TIFF, a RAW or any compressed or uncompressed data format. In one embodiment, music or audio files may be uploaded with the photographs and such files may be rendered while the photograph is being viewed.

Once the photographs have been placed in the workspace, in block 506, the photograph may be edited for insertion as a background photograph or image in the game window. Examples of editing may include cropping, rotating, shrinking to fit, skewing, increasing/decreasing of brightness/contrast, stretching, color adjusting, masking, and any other known photographic editing controls.

In block 508, the creator browses their computer for personal photographs or a clip art object that can be used as an object during play of the hidden object game. Such objects may be selected by the creator and uploaded onto the workspace. In one embodiment, the creator may choose an object from a selection of stock photographs or objects provided from a service provider and upload a stock photograph onto the workspace. Once uploaded on the workspace, the object may be placed onto the background photograph in block 510. The clipart may be manipulated in block 512 by resizing, rotating, moving and adjusting the opacity of the object that was placed on the background photograph. In another embodiment the clip art may be manipulated prior to placing the object on the workspace. When the object is placed on the background photograph in the workspace, the creator can move and adjust the opacity of the object in an attempt to hide their photograph object in the workspace in the background photograph.

In block 514, the creation tool ensures that the clip art objects and the background photograph comply with rules of the game. For example the tool may ensure that no clipart photo objects overlap already placed clip art. This will prevent the creator from fully hiding a clipart photograph behind another photograph. The tool may ensure that there is at least of predetermined number of hidden objects and not allow the game to be published unless there is rule compliance.

In block 516, a text or visual image list of the objects/clip art may be generated automatically or manually by the creator. This list may be placed in the list window and would correspond to the objects placed in the game window. The list may be generated from metadata stored with the objects. A timer may also be set by the creator to set the time period in which a user has to complete the game. Once a game and list window is created, the user may optionally be provided the ability to repeat steps 504 through 516, or repeat steps 508 through 516. Repeating these steps enable the user to add additional objects, or add an additional game and list window to provide a story or a narrative game like experience. The tool may also provide a limitation on the number of additional game and list widows that the creator may generate in a single game.

In block 516, the game may be named by the creator and saved to the database. Subsequently, assuming rule compliance the game may be published privately for use by an individual or the individual's family or friends, or may publish to a server 424 game site for public distribution at the option of the creator. For example the user may select with options provided with the game creation tool or provided on the server 424, which family or friends may obtain the game or whether the created game may be distributed to the public.

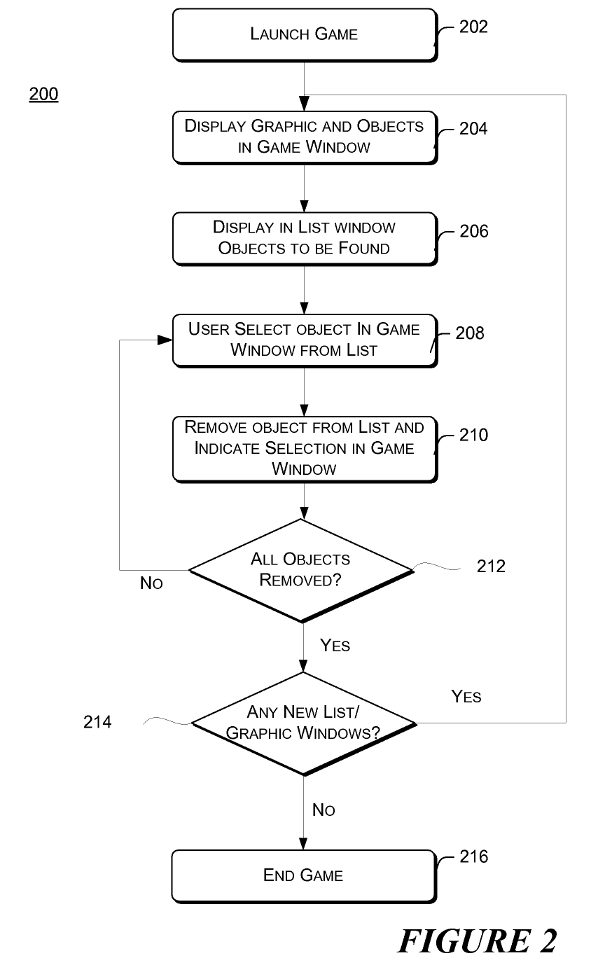

In block 520 the user may play the game or additional users may download and play the game described in FIGS. 1 and 2. Once the user plays the game, an indication may be provided to enable the user to vote on how they liked the game. The results of the vote may then be transferred to the service provider for aggregation and publication to other game players. A timer may be provided with the game that may be uploaded to the service provider upon game completion indicating how long it took for the user to complete the game. A hint could be incorporated into the game that would indicate a location of an object, but may provide a time penalty to the user if the hint were to be used. The uploaded times may be aggregated and published by the service provider under a “Today's Best Times field”. A game user may also be provided a menu from a web site or a menu in the game to indicate to the service provider if the game contains unlicensed or offensive content.

Various modules and techniques may be described herein in the general context of the computer-executable instructions, such as program modules, executed by one or more computers or other devices. Generally, program modules include routines, programs, control objects, components, control node data structures, etc. that perform particular tasks or implement particular abstract data types. Often, the functionality of the program modules may be combined or distributed as desired in various embodiments.

An implementation of the aforementioned computer video game may be stored on some form of the computer readable media (such as optical disk) or transmitted from the computer media via a communications media to a user computer. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any process or technology for storage of information such as computer readable instructions, control node data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The term “communication media” includes, but is not limited to, computer readable instructions, control node data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

### CONCLUSION

Above is described an apparatus and method for insertion of user selected graphics into a computer implemented video game. These and other techniques described herein may provide significant improvements over the current state of the art, to enable a non-technical individual to create and provide their own hidden objects game. Although the system and method has been described in language specific to structural features and/or methodological acts, it is to be understood that the system and method defined in the appended claims is not necessarily limited to the specific features or acts described. Rather, the specific features and acts are disclosed as illustrative forms of implementing the claimed system and method.

We claim:

1. A computer-based method for implementing a video game, the method comprising:
displaying a user interface graphics window;
retrieving a pictorial background for display in the user interface graphics window;
retrieving at least one object for placement on the pictorial background;
combining the pictorial background and the at least one object;
displaying text corresponding to the at least one object in a list window; and
indicating a selection of the at least one object.

2. The method as recited in claim 1, further comprising displaying instructions on the user interface graphics window for playing the video game.

3. The method as recited in claim 1, further comprising:
displaying a creation tool; and
editing, using the creation tool, an appearance of the user interface graphics window.

4. The method as recited in claim 1, wherein the retrieving of the pictorial background is from a memory of a user computer.

5. The method as recited in claim 1, wherein the retrieving of the pictorial background is from images including: animation, video images, photographs, manually generated graphical renderings and artistic renderings.

6. The method as recited in claim 1, further comprising:
displaying a creation tool; and
editing, using the creation tool, an appearance of the pictorial background.

7. The method as recited in claim 6, wherein the editing comprises at least one of cropping, rotating, shrinking to fit, skewing, increasing or decreasing brightness or contrast, stretching, color adjusting and masking.

8. The method as recited in claim 1, wherein the retrieving of the at least one object is from images including: animation, video images, photographs, manually generated graphical renderings and artistic renderings.

9. The method as recited in claim 1, wherein the retrieving of the at least one object is from a memory of a remotely located computer.

10. The method as recited in claim 1, further comprising:
displaying a creation tool; and
editing, using the creation tool, an appearance of the at least one object.

11. The method as recited in claim 10, wherein the editing comprises at least one of cropping, rotating, shrinking to fit, skewing, increasing or decreasing brightness or contrast, stretching, color adjusting, transparency adjusting and masking.

12. The method as recited in claim 1, further comprising:
storing the at least one object in a memory of a user computer;
storing metadata for the at least one object in the memory of the user computer; and
creating the list of text corresponding to the at least one object by retrieving the metadata for the at least one object.

13. The method as recited in claim 1, wherein the indicating the selection of the at least one object is performed by activating the at least one object.

14. The method as recited in claim 1, wherein the indicating the selection of the at least one object includes activating the list of text corresponding to the at least one object on the list window.

15. A computer-based method for implementing a video game, the method comprising:
displaying a user interface graphics window;
retrieving a pictorial background for display in the user interface graphics window;
retrieving at least one object for placement on the pictorial background;
combining the pictorial background and the at least one object;
receiving a selection of options for the video game;
displaying text corresponding to the at least one object in a list window; and
indicating a selection of the at least one object in the user interface graphics window.

16. The method as recited in claim 15, wherein the options for the video game comprises at least one of naming the video game, entering a running text, entering a game win text, saving the video game and publishing the video game.

17. The method as recited in claim 15, further comprising:
ensuring the at least one object and the pictorial background comply with rule requirements for the video game;
saving the video game only when the at least one object and the pictorial background comply with the rule requirements for the video game; and
publishing the video game only when the at least one object and the pictorial background comply with the rule requirements for the video game.

18. The method as recited in claim 17, wherein the rule requirements for the videogame comprises ensuring that there is at least a minimum number of the at least one object combining with the pictorial background.

19. The method as recited in claim 15, wherein the retrieving of the pictorial background and the at least one object is from images including: animation, video images, photographs, manually generated graphical renderings and artistic renderings.

20. The method as recited in claim 15, wherein the retrieving of the at least one object is from a memory of a remotely located computer.
